(19) United States
(12) Patent Application Publication
(10) Pub. No.: US 2019/0003524 A1
(43) Pub. Date: Jan. 3, 2019

(54) FOIL BEARING

(71) Applicant: SCHAEFFLER TECHNOLOGIES AG & CO. KG, Herzogenaurach (DE)

(72) Inventors: Wolfgang BRAUN, Garstadt (DE); Philipp WIRTH, Schweinfurt (DE)

(73) Assignee: SCHAEFFLER TECHNOLOGIES AG & CO. KG, Herzogenaurach (DE)

(21) Appl. No.: 16/060,168

(22) PCT Filed: Dec. 1, 2016
(86) PCT No.: PCT/DE2016/200567

§ 371 Date: Jun. 7, 2018

(30) Foreign Application Priority Data
Dec. 10, 2015 (DE) 10 2015 224 869.0

(51) Int. Cl. F16C 17/02; F16C 25/04; F16C 43/02; F16C 27/02

(52) U.S. Cl. CPC F16C 17/024; F16C 25/04; F16C 2360/00; F16C 27/02; F16C 43/02

(57) ABSTRACT

A foil bearing for supporting a shaft includes a sleeve-type bearing housing with three foil arrangements distributed around the inner circumference of the baring housing. Each foil arrangement covers a circumferential segment of the bearing housing. Each foil arrangement has a corrugated foil lying against an inner wall of the housing, and a top foil covering the corrugated foil. Each of the corrugated foil and the top foil has respective end edges. Each of the end edges are supported within the inner wall of the housing in a sliding manner. In particular, insertion grooves are formed in the inner surface of the housing which extend obliquely into the housing wall outwardly. The insertion grooves receive the end edges of the corrugated foil and the top foil.

### CROSS-REFERENCE TO RELATED APPLICATIONS

This application is the U.S. National Phase of PCT/DE2016/200567 filed Dec. 1, 2016, which claims priority to DE 102015224869.0 filed Dec. 10, 2015, the entire disclosures of which are incorporated by reference herein.

### TECHNICAL FIELD

This disclosure relates to a foil bearing for supporting a shaft, said bearing having a sleeve-type bearing housing with three foil arrangements distributed around the inner circumference of the bearing housing, each arrangement covering a circumferential segment of the bearing housing and having a corrugated foil lying against the inner wall of the housing and a top foil covering said corrugated foil. Each of the end edges of the top foils, said edges delimiting the top foils in the circumferential direction, are supported within the inner wall of the housing.

### BACKGROUND

Foil bearings involve hydrodynamic or aerodynamic bearings, in which the shaft or, in general, the bearing surface supporting the rotating rotor is formed by a thin, wear-resistant top foil, which, in turn, is supported by an elastic corrugated foil arranged between the top foil and the bearing housing wall. During operation, a hydrodynamic or aerodynamic film is formed between the shaft and the top foil, carrying the shaft. Direct contact between the shaft and the top foil only occurs during start and stop processes. Foil bearings of the type described may be used for shafts subject to low loads and running at high speeds, for example, in compressors, gas turbines, turbochargers and the like.

A reliable construction of bearings of the type described above are foil bearings configured in the form of so-called three-surface bearings, suitable for both directions of rotation, in which three foil arrangements each comprising a top foil and an associated corrugated foil, each cover an inner peripheral section of the bearing housing. For these bearings to be suitable for both directions of rotation, the foil arrangements must be equally fixed in both directions of rotation. In addition, they are usually constructed in such a way that the shaft is supported in three contact zones, i.e., in a basically statically determined fashion, which are evenly distributed over the shaft circumference, especially during operation in relation to the bearing section. In general, this requires a very complex structural and production-technical configuration, especially of the bearing housing.

US 2002/0054718 A1 discloses a foil bearing of the type mentioned above. The end edges of the top foils are supported on retaining bars, which are approximately T-shaped in cross-section and formed on the inside of the bearing housing. To produce the desired aerodynamic wedges required to form an aerodynamic film, the inner cross-section of the bearing sleeve is not circular, but is composed of three circular-arc segments, the radius of which is eccentrically offset in relation to the center of the bearing in such a way that converging gaps occur between shaft and bearing housing towards the contact zones. The elastic corrugated foils are not supported in the circumferential direction, i.e., they are only held by the top foils and elastically deformed by them in accordance with the shape of the converging gap in relation to a shaft height, which is in itself the same. Due to the retaining bars provided for supporting the top foils on the one hand and the complex inner cross-sectional shape of the bearing housing on the other hand, the well-known film bearings are very complex and expensive in terms of construction and production technology. In addition, due to the rigid support of the top foils on the retaining bars, the foil arrangements are not capable of adapting to deformations caused by mechanical or heat-related loads.

Against this background, a foil bearing is disclosed which is very simple in terms of construction and production technology, and in which the foil arrangements are capable of adapting to deformations occurring during operation.

### SUMMARY

Various solutions to the problem are disclosed herein and are provided in the claims.

This disclosure is based on a foil bearing for supporting a shaft, comprising a sleeve-like bearing housing with three foil arrangements distributed around the inner circumference of the bearing housing, each arrangement covering a circumferential segment of the bearing housing and having a corrugated foil lying against the inner wall of the housing and a top foil covering said corrugated foil. Each of the end edges of the top foils, said edges delimiting the top foils in the circumferential direction, are supported by the inner wall of the housing.

To achieve a solution to the problem at hand, it is provided that insertion grooves are formed in the inner face of the housing, the grooves extending along surface lines and projecting obliquely into the housing wall from the inside to the outside, each of said grooves holding one end edge of a top foil and one end edge formed on the associated corrugated foil; in the bearing-housing inner contour, which has a circular cross-section, the corrugated foils have corrugated heights that decrease, starting from their respective central regions towards their respective end edges in relation to the circumferential direction of the bearing housing.

On the one hand, a constructive and especially production-technical simplification of the bearing housing results from the fact that instead of retaining bars projecting radially to the inside to support the foil arrangements in circumferential direction, which generally require processing with high material removal, simple insertion grooves are inserted, for example, cut or eroded, into the bearing housing wall, into which the end edges of the foil arrangement can be simply inserted in axial fashion. Because of the fact that the insertion grooves hold the end edges of the top foils, as well as the end edges of the corrugated foils, said corrugated foils are also secured against displacement in circumferential direction. Another advantage of the inventive solution especially involves that the inner contour of the bearing housing is circular, the desired converging gaps being formed by a special new configuration of the corrugated foils, said corrugated foils having corrugated heights that decrease, starting from their respective central regions towards their respective end edges, which shall be described in more detail in an embodiment.

One embodiment provides that the insertion grooves hold the associated end edges of the top foils and corrugated foils with a sliding fit, and that the depth of the insertion grooves is greater than the penetration depth of the associated end edges with unloaded top foil. The depth of the insertion grooves is adjusted to the length of the top foils and corrugated foils in such a way that the end edges of the foil arrangements held with a sliding fit in the insertion grooves can move in the insertion grooves and thus the foil arrangements can adapt to the respective operating conditions during temperature-induced expansion of the foils, as well as with a change in length due to the bearing load.

According to a further embodiment, it is provided that in the region of each of the two insertion grooves assigned to a foil arrangement one or more threaded holes penetrating the housing wall are provided, these threaded holes holding clamping screws, which fix the end edges in the respective insertion groove. At the same time, the adjustment to the respective operating conditions described above occurs at the end of the foil arrangement not fixed. In this way, it is possible to provide for any combination of fixed foil arrangements or foil arrangements fixed on one side. At the same time, the clamping screws are used for securing the foil arrangements in axial direction of the foil bearing.

### BRIEF DESCRIPTION OF THE DRAWINGS

Various embodiments of the foil bearing are described in more detail in the attached drawings. It is shown:

FIG. 1 shows a cross-section through an inventive foil bearing, which is configured in the form of a three-surface bearing,

FIG. 2 shows a magnified detail of the representation shown in FIG. 1,

FIG. 3 shows a perspective view of a bearing housing for a foil bearing, and

FIG. 4 shows a schematic view of a corrugated foil for a foil bearing according to FIG. 1.

### DETAILED DESCRIPTION OF THE DRAWINGS

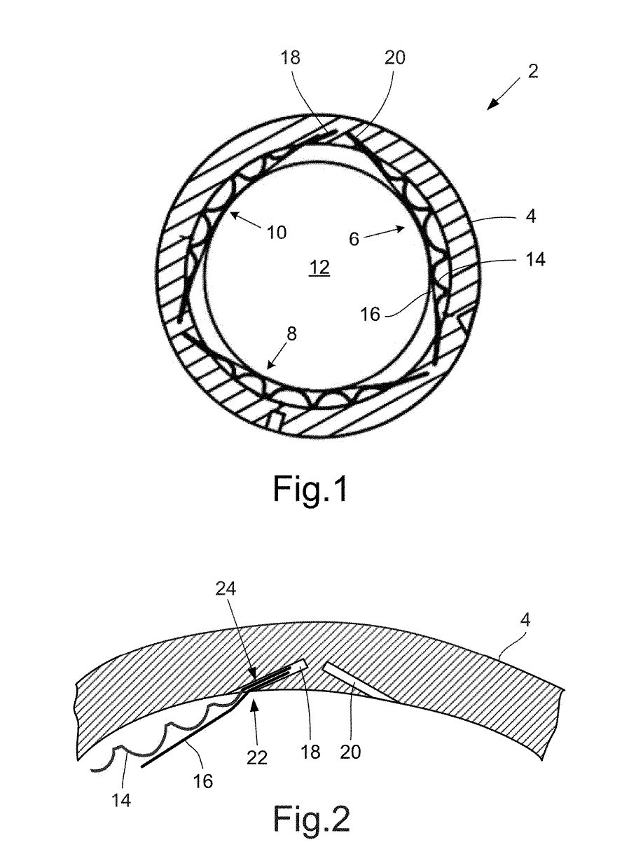

The foil bearing 2 represented in FIG. 1 configured in the form of a so-called three-surface bearing comprises a sleeve-type bearing housing 4, three foil arrangements 6, 8, 10 distributed around the inner circumference of the bearing housing 4, and one shaft 12 pivoted in the foil bearing.

Each of the three foil arrangements 6, 8, 10 comprises a corrugated foil 14 directly attached to the inner wall of the bearing housing 4 and a top foil 16 covering the corrugated foil. Insertion grooves 18, 20 are formed in the inner face of the housing, the grooves extending along surface lines of the bearing housing and projecting obliquely into the housing wall from the inside to the outside, each of said grooves holding one end edge 22 of a top foil and one end edge 24 formed on the associated corrugated foil 14, which is clearly depicted in FIG. 2. Basically, the alignment of the insertion grooves 18, 20 follows the alignment of the end edges 22, 24 extending in circumferential direction.

The inner contour of the bearing housing 4 has a circular cross-section, and the corrugated foils 14 have corrugated heights H, h that decrease starting from their respective central region 26 in relation to the circumferential direction of the bearing housing 4 towards their respective end edges 24, as shown in FIG. 4. For example, the difference h of the corrugated heights from the center of the corrugated foil towards the end edges can amount to between 10 and 100% of the maximum corrugated height H.

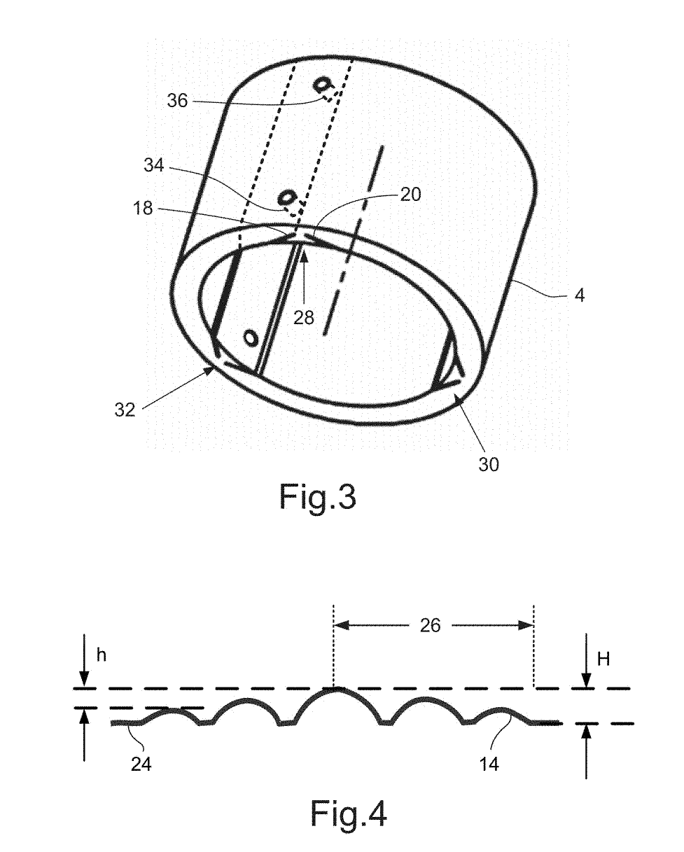

FIG. 3 shows a perspective view of a bearing housing 4 for a so-called three-surface bearings, having three insertion groove pairs 28, 30, 32, each offset by 120° and distributed around the circumference, each of which holding end edges 22, 24 of adjacent foil arrangements 6, 8, 10. To fix the foil arrangements 6, 8, 10 especially in axial direction of the foil bearing 2, two threaded holes 34, 36 penetrating the housing wall are provided respectively in the region of one of the two insertion grooves 18, 20 assigned to a foil arrangement 6, 8, 10, which threaded holes hold clamping screws that fix the end edges 22, 24 in the respective insertion groove (not shown). If required, respective threaded holes and clamping screws can also be associated with each insertion groove.

### LIST OF REFERENCE SYMBOLS

2 foil bearing
4 bearing housing
6 first foil arrangement
8 second foil arrangement
10 third foil arrangement
12 shaft
14 corrugated foil
16 top foil
18 insertion groove
20 insertion groove
22 end edge
24 end edge
26 region
28 first insertion groove pair
30 second insertion groove pair
32 third insertion groove pair
34 first threaded hole
36 second threaded hole

1. A foil bearing for supporting a shaft, said bearing comprising:
a sleeve-type bearing housing with three foil arrangements distributed around an inner circumference of the bearing housing, each foil arrangement:
covering a circumferential segment of the bearing housing,
having a corrugated foil lying against an inner surface of the bearing housing; and
having a top foil covering said corrugated foil and having end edges delimiting the top foil in a circumferential direction, the end edges supported by the inner surface of the housing,
wherein insertion grooves are formed in the inner surface of the housing, the grooves extending along surface lines and projecting obliquely outwardly into the housing, each of said grooves holding one of the end edges and one end edge of the associated corrugated foil, and wherein with a circular cross-sectional inner contour of the bearing housing the corrugated foils have corrugated heights that decrease starting from a respective central region in relation to the circumferential direction of the bearing housing towards their respective end edges.

2. A foil bearing according to claim 1, wherein the insertion grooves hold the end edges of the top foil and the end edges of the corrugated foils with a sliding fit, and that a depth of the insertion grooves is greater than a penetration depth of the associated end edges.

3. A foil bearing according to claim 1, wherein in a region of each insertion groove, one or more threaded holes penetrating the housing wall are provided, the threaded holes holding clamping screws, which fix the end edges of the top foil and the end edges of the corrugated foils in the respective insertion groove.

4. A foil bearing for supporting a shaft, the foil bearing comprising:
a sleeve-type bearing housing having an inner circumferential surface with three foil arrangements distributed about an inner circumferential surface, each foil arrangement including:
a corrugated foil lying against the inner circumferential surface of the bearing housing and having two end edges, and
a top foil having two end edges;
wherein the bearing housing includes at least six insertion grooves extending outwardly from the inner circumferential surface, each insertion groove receiving one of the end edges of one of the corrugated foil and one of the end edges of one of the top foils.

5. The foil bearing of claim 4, wherein the corrugated foils each have a height of corrugation that varies.

6. The foil bearing of claim 5, wherein the corrugated foils include a first corrugated foil that has a height of corrugation that decreases in a direction from a central region of the first corrugated foil toward to the end edges of the first corrugated foil.

7. The foil bearing of claim 4, wherein the end edges of the top foils and the end edges of the corrugated foils do not extend entirely into the insertion grooves.

8. The foil bearing of claim 7, wherein the end edges of the top foils and the end edges of the corrugated foils are received in the insertion grooves in a sliding manner.

9. The foil bearing of claim 4, wherein the bearing housing includes one or more threaded holes each located at a respective region of one of the insertion grooves, the threaded holes holding clamping screws which each fix one of the end edges of the top foils and one of the end edges of the corrugated foils in a respective one of the insertion grooves.

10. A foil bearing comprising:
a bearing housing having an inner surface sized to receive a central shaft, the inner surface defining a plurality of insertion grooves extending outwardly therefrom;
a plurality of first foils, each of the first foils having two end edges; and
a plurality of second foils, each of the second foils located radially between the bearing housing and a respective one of the first foils, each of the second foils having two end edges;
wherein each end edge of the first foil engages with a respective one of the end edges of one of the second foils within a respective one of the insertion grooves.
